(19) United States
(12) Patent Application Publication
(10) Pub. No.: US 2025/0233650 A1
(43) Pub. Date: Jul. 17, 2025

(54) ADAPTING MOBILITY UNDER DISCONTINUOUS COVERAGE

(71) Applicant: InterDigital Patent Holdings, Inc., Wilmington, DE (US)

(72) Inventors: Dylan Watts, Montreal (CA); Brian Martin, Farnham (GB); Oumer Teyeb, Montreal (CA); Keiichi Kubota, Tokyo (JP)

(73) Assignee: InterDigital Patent Holdings, Inc., Wilmington, DE (US)

(21) Appl. No.: 18/703,184

(22) PCT Filed: Oct. 19, 2022
(86) PCT No.: PCT/US2022/047122

§ 371 Date: Apr. 19, 2024

Related U.S. Application Data
(60) Provisional application No. 63/257,374, filed on Oct. 19, 2021.
(60) Provisional application No. 63/391,427, filed on Jul. 22, 2022.

(51) Int. Cl. H04B 7/185; H04W 36/00

(52) U.S. Cl. CPC H04B 7/18519; H04W 36/0058

(57) ABSTRACT

Systems, methods, and instrumentalities are described herein for adapting mobility under discontinuous coverage (e.g., associated with gap(s) in coverage). In examples, a WTRU may determine the start and duration of discontinuous coverage. Discontinuous coverage may be explicitly indicated in SI (e.g., start UTC 10:00+90 s). The determination of the start and duration of discontinuous coverage may be implicitly determined via assistance information broadcasted in a SI cell stop time and a neighboring cell start time. The start and duration of discontinuous coverage may be calculated via location information (e.g., the distance between the WTRU and serving/neighboring cell center and the diameter of cell coverage). The WTRU may report it is about to enter a coverage gap at some configured offset from time (e.g., via a timer) of the coverage gap.

### CROSS-REFERENCE TO RELATED APPLICATIONS

This application claims the benefit of Provisional U.S. Patent Application No. 63/257,374, filed Oct. 19, 2021, and Provisional U.S. Patent Application No. 63/391,427, filed Jul. 22, 2022, the disclosures of which are incorporated herein by reference in their entireties.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are described herein that relate to adapting mobility under discontinuous coverage.

A wireless transmit/receive unit (WTRU) may be configured to determine a start and duration of discontinuous coverage (e.g., a coverage gap) based on received assistance information (e.g., satellite assistance information). The WTRU may transmit a coverage gap report based on the determination of the coverage gap. The coverage gap report may include a start of the coverage gap (e.g., a time in which the WTRU estimates it will enter the coverage gap). The coverage gap report may include a duration of the coverage gap (e.g., an estimated duration of the coverage gap). The coverage gap report may include an incoming target ID or a cell ID.

The WTRU may receive a first message. The first message may be a radio resource control (RRC) reconfiguration message. The first message may be or include a suspend indication. The first message (e.g., the suspend indication) may be received from a non-terrestrial network (NTN). The first message may indicate a first action for the WTRU to perform while in the coverage gap. In examples, the first action may be a suspend action. The suspend action may include at least one of: suspension of an uplink (UL) transmission, a suspension of a downlink (DL) transmission, a suspension of a timer or counter, a suspension of a neighbor cell measurement, or a suspension of radio link monitoring (RLM). In examples, the first action may be an action configuring the WTRU for a power saving operation. The first message (e.g., the suspend indication) may indicate a condition to resume in-coverage operation. The condition to resume in-coverage operation may be an absolute universal time coordinated (UTC) being reached. The condition to resume in-coverage operation may be a target measurement being above a threshold. The first message may indicate a target cell configuration.

The WTRU may release a source cell (e.g., if entering a coverage gap area). The source cell may belong to the NTN. The WTRU may perform the first action (e.g., the suspend action) while in the coverage gap. Based on the condition to resume in-coverage operation being satisfied, the WTRU may perform a second action, apply the target cell configuration, and synchronize to a target cell. The second action may be an action to resume the actions suspended (e.g., resume normal procedures). The WTRU may transmit a second message to the target cell. The second message may be a RRC reconfiguration complete message. The target cell may belong to the NTN.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of different interfaces in a non-terrestrial network (NTN).

FIG. 3 illustrates an example of a WTRU within an NTN network with continuous coverage.

FIG. 4 illustrates another example of a WTRU within an NTN network with continuous coverage.

FIG. 5 illustrates an example for suspended mobility during a coverage gap.

### DETAILED DESCRIPTION

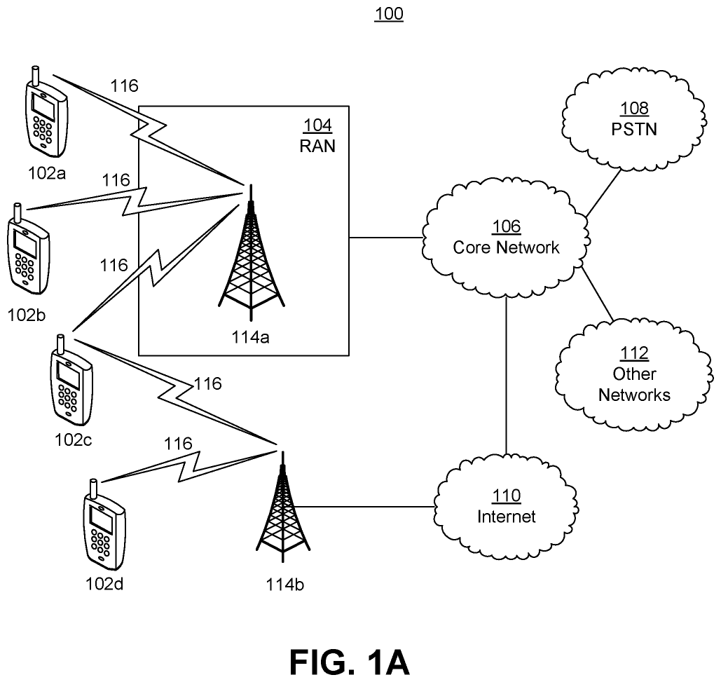

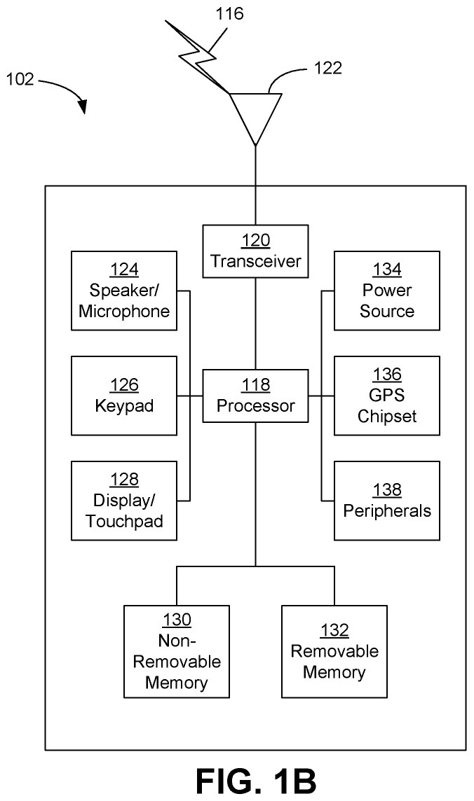

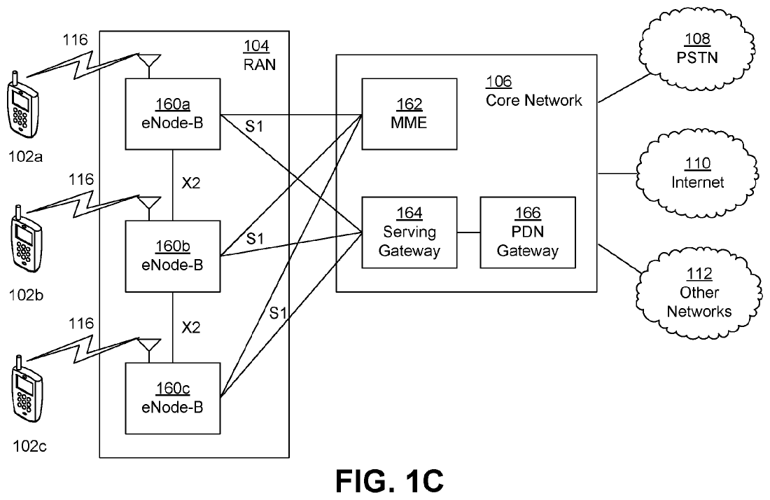

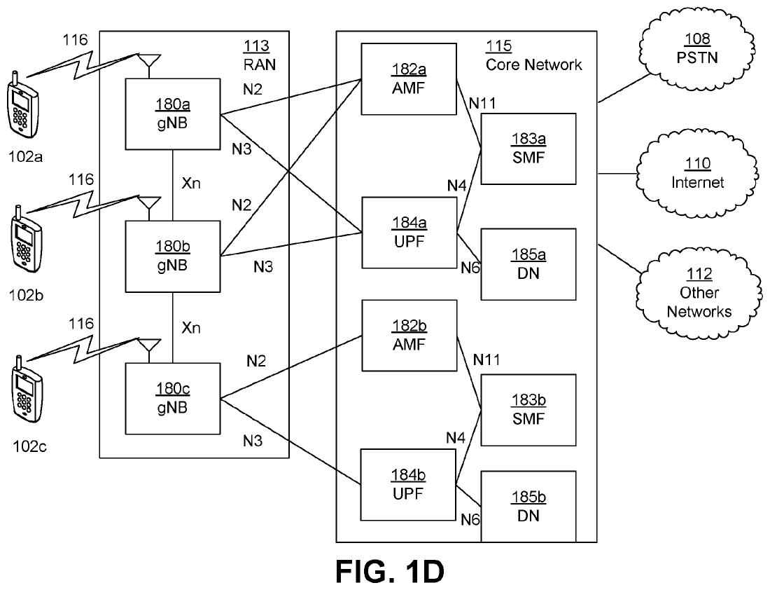

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein that relate to adapting mobility under discontinuous coverage.

A wireless transmit/receive unit (WTRU) may be configured to determine a start and duration of discontinuous coverage (e.g., a coverage gap) based on received assistance information (e.g., satellite assistance information). The WTRU may transmit a coverage gap report based on the determination of the coverage gap. The coverage gap report may include a start of the coverage gap (e.g., a time in which the WTRU estimates it will enter the coverage gap). The coverage gap report may include a duration of the coverage gap (e.g., an estimated duration of the coverage gap). The coverage gap report may include an incoming target ID or a cell ID.

The WTRU may receive a first message. The first message may be a radio resource control (RRC) reconfiguration message. The first message may be or include a suspend indication. The first message (e.g., the suspend indication) may be received from a non-terrestrial network (NTN). The first message may indicate a first action for the WTRU to perform while in the coverage gap. In examples, the first action may be a suspend action. The suspend action may include at least one of: suspension of an uplink (UL) transmission, a suspension of a downlink (DL) transmission, a suspension of a timer or counter, a suspension of a neighbor cell measurement, or a suspension of radio link monitoring (RLM). In examples, the first action may be an action configuring the WTRU for a power saving operation. The first message (e.g., the suspend indication) may indicate a condition to resume in-coverage operation. The condition to resume in-coverage operation may be an absolute universal time coordinated (UTC) being reached. The condition to resume in-coverage operation may be a target measurement being above a threshold. The first message may indicate a target cell configuration.

The WTRU may release a source cell (e.g., if entering a coverage gap area). The source cell may belong to the NTN. The WTRU may perform the first action (e.g., the suspend action) while in the coverage gap. Based on the condition to resume in-coverage operation being satisfied, the WTRU may perform a second action, apply the target cell configuration, and synchronize to a target cell. The second action may be an action to resume the actions suspended (e.g., resume normal procedures). The WTRU may transmit a second message to the target cell. The second message may be a RRC reconfiguration complete message. The target cell may belong to the NTN.

In examples, discontinuous coverage (e.g., a coverage gap) may be explicitly indicated in SI (e.g., start UTC 10:00+90 s). In examples, the determination of the start and duration of discontinuous coverage (e.g., a coverage gap) may be implicitly determined via assistance information (e.g., satellite assistance information) broadcasted in a SI cell stop time and a neighboring cell start time. The start and duration of discontinuous coverage (e.g., a coverage gap) may be calculated via location information (e.g., the distance between the WTRU and serving/neighboring cell center and the diameter of cell coverage). The WTRU may report that it is about to enter a coverage gap at some configured offset (e.g., via a timer) from the start time of the coverage gap.

Examples of enhancements for mobility procedure may be provided. The first message (e.g., suspend indication) may include a RRC configuration for a target cell. The first message (e.g., suspend indication) may include an indication of when to apply a configuration. The first message (e.g., suspend indication) may order to stop/suspend timers or counters. If the WTRU enters a discontinuous coverage area (e.g., a coverage gap area) (or if the WTRU satisfies the conditions within suspend indication), the WTRU may release a source cell prior to establishment of connection to a target cell, the WTRU may suspend radio link monitoring (RLM)/radio link failure (RLF) procedures, or the WTRU may not attempt reestablishment. In examples, the WTRU may suspend measurements or stop/offset timers. At a fixed distance and time (e.g., via a timer) from the target cell (or if resume conditions within suspend indication are satisfied), the WTRU may apply configuration and synchronization to the target cell. The configuration and synchronization may include pre-compensation, measurements, etc. If the synchronization is successful, the WTRU may send a RRC complete message to the target cell.

Examples of enhancements if conditional handover (CHO) configurations for a target cell are provided are included. The WTRU may be provided with a CHO configuration. The CHO configuration may be valid (e.g., during a time range or distance from the target cell). If the WTRU enters a discontinuous coverage area (e.g., a coverage gap area) (or if the WTRU satisfies the conditions within suspend indication), the WTRU may no longer consider a serving cell as valid but maintain stored CHO configurations, the WTRU may suspend RLM/RLF procedures, or the WTRU may not attempt reestablishment. In examples, the WTRU may suspend measurements or stop/offset timers. If the WTRU enters a discontinuous coverage area (e.g., a coverage gap area) (or if the WTRU satisfies the conditions within suspend indication), the WTRU may apply configuration and start performing measurements/execute mobility.

Examples of enhancements to connection reestablishment (e.g., RRC connection reestablishment) are included. If the WTRU enters a discontinuous coverage area (e.g., a coverage gap area) (e.g., which may be triggered if a time (e.g., T310 timer used as an example) is started or expired), the WTRU may suspend RLM/RLF procedures or the WTRU may not attempt reestablishment. In examples, the WTRU may suspend serving cell and neighbor cell measurements, cell selection, and/or stop/offset timers. At a fixed distance or time (e.g., via a T310 timer) from the target cell, the WTRU may resume RLF procedure. The WTRU may resume or start a T310 timer or may consider T310 as expired and start another timer (e.g., start T311). The WTRU may attempt (e.g., first attempt) reestablishment on an indicated neighbor cell (e.g., the neighbor cell may serve as a “fallback” cell) without performing a full cell selection (e.g., performing a comprehensive search which may involve detecting suitable cells on various frequencies, etc.). If a coverage gap is detected, trigger condition(s) are satisfied, or a gNB request is received, the WTRU may transmit a coverage gap report (e.g., a coverage gap report MAC CE) including information relevant to the coverage gap.

Examples of enhancements associated with mobility and CHO procedures to accommodate a non-contiguous coverage scenario are provided. Examples of minimizing RLM and suspension of RLF procedures while in a coverage gap are provided. Mechanisms that may prevent handover failure and avoid pre-mature discarding or CHO configuration are provided. Such enhancements may reduce WTRU power consumption (e.g., by avoiding unnecessary physical downlink control channel (PDCCH) monitoring while in a coverage gap scenario, ensure synchronization between the WTRU and network regarding WTRU reachability, and/or avoid premature RLF declaration based on WTRU misinterpretation of discontinuous coverage (e.g., a coverage gap) vs coverage loss).

A WTRU may determine the start and duration of discontinuous coverage (e.g., a coverage gap). Discontinuous coverage (e.g., a coverage gap) may be explicitly indicated in SI (e.g., using a start time, such as start UTC 10:00+90 s). The start and duration of discontinuous coverage (e.g., a coverage gap) may be implicitly determined via assistance information (e.g., satellite assistance information) broadcasted in a SI cell stop time and a neighboring cell start time. The start and duration of discontinuous coverage (e.g., a coverage gap) may be calculated via location information (e.g., the distance between the WTRU and serving/neighboring cell center and diameter of cell coverage). A WTRU may report it is about to enter a coverage gap. A WTRU may receive a suspended mobility indication. The suspended mobility indication may include a RRC configuration for a target cell, an indication of when to apply the configuration (e.g., the target cell configuration), and/or an order to stop/suspend timers or counters. If entering the discontinuous coverage area (e.g., the coverage gap area), the WTRU may release a source cell, suspend RLM/RLF procedures, and/or not attempt reestablishment. The WTRU may suspend serving cell and neighbor cell measurements or stop/offset timers. At a fixed distance/time from the target cell, the WTRU may apply the configuration (e.g., the target cell configuration) and synchronize to the target cell. The configuration and synchronization may include pre-compensation, measurements, etc. If synchronization is successful, the WTRU may send a RRC complete message to the target cell.

A WTRU may be provided with a CHO configuration. The CHO configuration may be valid (e.g., during a time range or distance from a target cell). A WTRU may determine the start and duration of discontinuous coverage area (e.g., a coverage gap area). The discontinuous coverage area (e.g., the coverage gap area) may be explicitly indicated in SI (e.g., using a start time, such as start UTC 10:00+90 s). The start and duration of the discontinuous coverage area (e.g., the coverage gap area) may be implicitly determined via assistance information (e.g., satellite assistance information) broadcasted in a SI cell stop time and a neighboring cell start time. The duration may be a time duration of the discontinuous coverage area (e.g., the coverage gap area). The duration may be a distance duration of the discontinuous coverage area (e.g., the coverage gap area). The start and duration of discontinuous coverage (e.g., coverage gap) may be calculated via location information (e.g., the distance between the WTRU and serving/neighboring cell center and diameter of cell coverage). If entering the discontinuous coverage area (e.g., the coverage gap area), the WTRU may no longer consider a serving cell as valid, may maintain stored CHO configurations, may suspend RLM/RLF procedures, and/or may not attempt reestablishment. The WTRU may suspend serving cell and neighbor cell measurements and/or stop/offset timers. At a fixed distance/time from the target cell, the WTRU may apply the CHO configuration and start performing measurements/execute mobility.

A WTRU may determine the start and duration of discontinuous coverage (e.g., a coverage gap). The discontinuous coverage (e.g., coverage gap) may be explicitly indicated in SI (e.g., using a start time, such as start UTC 10:00+90 s). The start and duration of discontinuous coverage (e.g., the coverage gap) may be implicitly determined via assistance information (e.g., satellite assistance information) broadcasted in a SI cell stop time and a neighboring cell start time. The start and duration of discontinuous coverage (e.g., a coverage gap) may be calculated via location information (e.g., the distance between the WTRU and serving/neighboring cell center and diameter of cell coverage). If entering a discontinuous coverage area (e.g., a coverage gap area), which in examples may be triggered if T310 starts or expires, the WTRU may suspend RLM/RLF procedures and/or may not attempt reestablishment.

The WTRU may suspend serving cell and neighbor cell measurements and cell selection and/or stop/offset timers. At a fixed distance/time from the target cell, the WTRU may resume a RLF procedure. The WTRU may resume/start a T310 timer or may consider T310 as expired and start T311. The WTRU may attempt reestablishment on the indicated neighbor cell associated with the cell start time without performing a full cell selection.

Examples of NTNs may be provided. An NTN may facilitate deployment of wireless networks in areas where land-based antennas are impractical, for example, due to geography or cost. It is envisioned that, coupled with terrestrial networks, an NTN may enable truly ubiquitous coverage of networks (e.g., 5G networks). NTN deployments may support basic talk and text anywhere in the world; however, it may be expected that releases (e.g., further releases) coupled with proliferation of next-generation low-orbit satellites may enable enhanced services such as web browsing.

An NTN (e.g., a basic NTN) may include an aerial or space-borne platform which, via a gateway (GW), may transport signals from a land-based based gNB to a WTRU and vice-versa. An NTN may support a power class 3 WTRU with an omnidirectional antenna and linear polarization, or a very small aperture antenna (VSAT) terminal with a directive antenna and circular polarization. LTE-based narrow-band IoT (NB-IoT) and eMTC type devices may be provided herein. Regardless of device type, NTN WTRUs may be global navigation satellite system (GNSS) capable.

Aerial or space-borne platforms are classified in terms of orbit, which may be low-earth orbit (LEO) satellites with altitude ranges of 300-1500 km, for example, and geostationary earth orbit (GEO) satellites with altitudes at 35-786 km, for example. Platform classifications may be provided such as medium-earth orbit (MEO) satellites with altitude ranges of 7000-25000 km, for example, and high-altitude platform stations (HAPS) with altitudes of 8-50 km, for example. Satellite platforms may be classified (e.g., further classified) as having a “transparent” or “regenerative” payload. Transparent satellite payloads may implement frequency conversion and RF amplification in both UL and DL, with multiple transparent satellites possibly connected to a land-based gNB. Regenerative satellite payloads may implement either a full gNB or gNB DU onboard the satellite. Regenerative payloads may perform digital processing on the signal including at least one of the following: demodulation, decoding, re-encoding, re-modulation, or filtering.

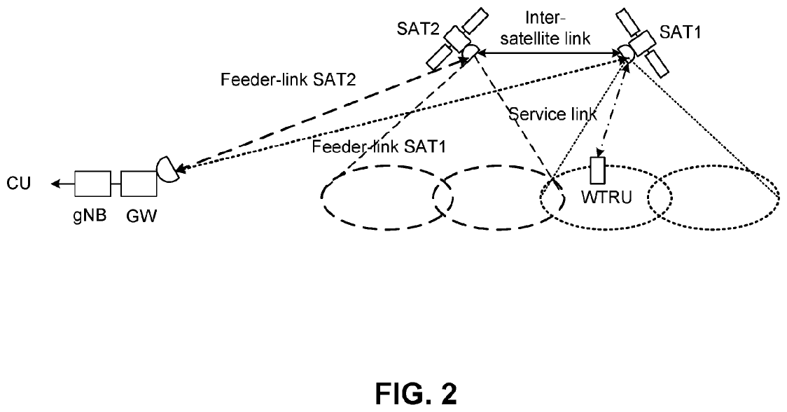

FIG. 2 illustrates an example of different interfaces in a NTN. The following interfaces include at least one of the following: a feeder-link, a service link, or an inter-satellite link (ISL). A feeder-link may be a wireless link between the GW and satellite. A service link may be a radio link between the satellite and WTRU. An ISL may be a transport link between satellites. The ISL may be supported regenerative periods (e.g., only by regenerative payloads) and may be a 3GPP radio or proprietary optical interface.

Depending on the satellite payload configuration, different 3GPP interfaces may be used for radio links (e.g., each radio link). In a transparent payload, the NR-Uu radio interface may be used for (e.g., used for both) the service link and feeder-link. For a regenerative payload, the NR-Uu interface may be used on the service link, and a satellite radio interface (SRI) may be used for the feeder-link.

An NTN satellite may support multiple cells. The multiple cells (e.g., each cell) may include one or more satellite beams. Satellite beams may cover a footprint on earth (e.g., a terrestrial cell) and may range in diameter from 100-1000 km in LEO deployments, and 200-3500 km diameter in GEO deployments. Beam footprints in GEO deployments may remain fixed relative to earth. In LEO deployments, the area covered by a beam/cell may change over time due to satellite movement. This beam movement may be classified as “earth moving” where the LEO beam moves continuously across the earth, or “earth fixed” where the beam is steered to remain covering a fixed location until a new cell overtakes the coverage area in a discrete and coordinated change.

Due to the altitude of NTN platforms and beam diameter, the round-trip time (RTT) and maximum differential delay may be significantly larger than that of terrestrial systems. In a typical transparent NTN deployment, RTT may range from 25.77 ms (LEO @600 km altitude) to 541.46 ms (GEO) and maximum differential delay from 3.12 ms to 10.3 ms, for example. The RTT of a regenerative payload may be approximately half that of a transparent payload, as a transparent configuration may include both the service and feeder links, whereas the RTT of a regenerative payload may consider the service link only. To minimize impact to existing NR systems (e.g., to avoid preamble ambiguity or properly time reception windows), prior to initial access, a WTRU may perform timing pre-compensation.

The WTRU may obtain its position via GNSS during the pre-compensation procedure, and the feeder-link (or common) delay and satellite position via satellite ephemeris data. The satellite ephemeris data may be periodically broadcasted in system information, and may include the satellite speed, direction, and velocity. The WTRU may estimate the distance (and thus delay) from the satellite and may add the feeder-link delay component to obtain the full WTRU-gNB RTT, which may be used (e.g., may then be used) to offset timers, reception windows, or timing relations. Frequency compensation may be performed by the network.

Examples of WTRU mobility and measurement reporting are provided. The difference in reference signal received power (RSRP) between the cell center and the cell edge may not be as pronounced as in terrestrial systems. This, coupled with the much larger region of cell overlap, may result in traditional measurement-based mobility to become less reliable in an NTN environment. CHO and measurement reporting triggers may be provided relying on location and time. Enhanced mobility may occur in LEO deployments where, due to satellite movement, even a stationary WTRU may be expected to perform mobility often (e.g., approximately every 7 seconds (depending on deployment characteristics)).

Examples of connected mobility in NR are provided. Explicit RRC signaling may be triggered for cell level mobility in NR, where the source gNB may indicate the current serving cell and the target gNB may indicate the cell which the WTRU is about to transition to. For inter-gNB mobility, the source gNB may configure the WTRU measurement procedure (e.g., measurement objects, reporting event) and the WTRU may report according to measurement configuration. Measurement reporting may be periodic or may be triggered based on an event, such as neighboring cell measurements exceeding a threshold. Based on the measurement report and other radio resource management (RRM) information, the source gNB may decide to handover the WTRU.

The source gNB may issue a handover request message to the target gNB passing a transparent RRC container with information (e.g., necessary information) to prepare the handover at the target side. The information may include at least the target cell ID, KgNB*, the cell radio network temporary identifier (C-RNTI) of the WTRU in the source gNB, RRM-configuration including WTRU inactive time, basic AS-configuration including antenna info and DL carrier frequency, the current QoS flow to a data radio bearer (DRB) mapping rules applied to the WTRU, the SIB1 from source gNB, the WTRU capabilities for different RATs, protocol data unit (PDU) session related information, and the WTRU reported measurement information including beam-related information if available. The PDU session related information may include the slice information and QoS flow level QoS profile(s). Admission control may (e.g., may then) be performed by the target gNB.

The target gNB may prepare the handover with L1/L2 and send the HANDOVER REQUEST ACKNOWLEDGE to the source gNB, which may include a transparent container to be sent to the WTRU as a RRC message to perform the handover. When the source gNB receives (e.g., as soon as the source gNB receives) the HANDOVER REQUEST ACKNOWLEDGE, or when the transmission (e.g., as soon as the transmission) of the handover command is initiated in the DL, data forwarding may be initiated.

The source gNB may trigger the Uu handover by sending an RRCReconfiguration message to the WTRU. The RRCReconfiguration message may include at least one of the following information required to access the target cell: the target cell ID, the new C-RNTI, or the target gNB security algorithm identifiers for the selected security algorithms. The RRCReconfiguration message may (e.g., may also) include at least one of: a set of dedicated random access channel (RACH) resources, the association between RACH resources and SSB(s), the association between RACH resources and WTRU-specific channel state information reference signal (CSI-RS) configuration(s), common RACH resources, or system information of the target cell.

The WTRU may synchronize to the target cell and complete the RRC handover procedure by sending a RRCReconfigurationComplete message to a target gNB. The WTRU may (e.g., may then) release the source resources.

Examples of CHO are provided. A CHO may be defined as a handover that is executed by the WTRU if one or more handover execution conditions are met. The WTRU may start evaluating the execution condition(s) if receiving the CHO configuration and may stop evaluating the execution condition(s) if a handover is executed.

In general, the CHO configuration may include the configuration of CHO candidate cell(s) by the candidate gNB(s) and execution condition(s) generated by the source gNB, where an execution condition may include one or two trigger conditions (e.g., A3/A5 type event). If a HO command is received (e.g., regardless of any previously received CHO configuration), the WTRU may execute the HO procedure. While executing the CHO, the WTRU may not monitor the source cell.

The WTRU may maintain connection with the source gNB after receiving the CHO configuration, and may evaluate (e.g., may start evaluating) the CHO execution conditions for the candidate cell(s). If at least one CHO candidate cell satisfies the corresponding CHO execution condition, the WTRU may detach from the source gNB, apply the stored corresponding configuration for that selected candidate cell, synchronize to that candidate cell, and complete the RRC handover procedure by sending a RRCReconfigurationComplete message to the target gNB. The WTRU may release stored CHO configurations after successful completion of a RRC handover procedure.

Example CHO enhancements in NTNs may be provided. CHO trigger conditions may be based on RSRP based events (e.g., A3 or A5). In an NTN, trigger conditions (e.g., additional trigger conditions) based on time and location may be jointly configured with an RSRP-based condition.

For a time based CHO condition, the WTRU may be provided with a UTC time (e.g., in addition to a duration/timer which may represent a time range between T1 and T2). Between T1 and T2, the WTRU may consider the candidate cell valid, and may perform a CHO if other trigger conditions (e.g., all other trigger conditions (e.g., RSRP based)) are jointly satisfied.

Location-based CHO triggers may support at least the following two events: condEvent L4 which is the distance between the WTRU and a PCell's reference location that becomes larger than absolute threshold1; and the distance between the WTRU and a conditional reconfiguration candidate that becomes shorter than absolute threshold2. The WTRU may consider a candidate cell valid and perform CHO if the above configuration is satisfied jointly with other CHO conditions (e.g., RSRP-based conditions).

Examples of RLF are provided. RLF detection and recovery procedure in NR, LTE, or NB-IoT may be a mechanism to recover an RRC connection, either on the same cell or on a new cell, if detection of failure occurs. The WTRU may start the RLF procedure when detecting N310 out-of-sync indications on a PCell from the physical layer. At the start of the RLF procedure, the WTRU may start a timer T310. For the duration of T310 (e.g., until the timer expires), the WTRU may attempt to re-synchronize to the cell on which out-of-sync was detected. If the WTRU receives N311 in-sync indications from the physical layer, the WTRU may stop the timer T310 and consider the procedure to have ended (e.g., and consider the connection to have been recovered).

If T310 expires, the WTRU may consider RLF to have been detected. The WTRU may release the RRC connection associated with the cell on which RLF has been detected and begin a RRC reestablishment procedure. The WTRU may start timer T311 and perform a cell selection. Cell selection may cause the WTRU to perform a scan of supported RATs and carriers in an attempt to find an (e.g., alternative) suitable cell. If a suitable cell is found while T311 is running, the WTRU may attempt to reestablish the RRC connection on that cell (e.g., which may be the same or another cell). If T311 expires, then the RRC reestablishment procedure may be considered to have failed and the WTRU may enter idle mode with the cause RRC connection failure.

NTN support for IoT devices may be provided for devices supporting eMTC and/or NB-IoT. The RLF and RRC reestablishment procedure may be enhanced for support of discontinuous coverage (e.g., a coverage gap) in NR, LTE eMTC, or NB-IoT. NB-IoT devices may not support measurement reporting or handover in connected mode. Instead, connected mode mobility between cells may rely on RLF and RRC reestablishment on the new cell.

In LEO deployments, as a satellite moves overhead, there may become a transition point where the satellite has moved sufficiently far from the geographic location of the WTRU that the satellite no longer provides suitable coverage. For a earth fixed beam, this loss of coverage may occur (e.g., may occur simultaneously) for WTRU (e.g., all WTRUs) within a boundary cell. For earth-moving beams, this loss of coverage may happen gradually as the outer boundary of the cell moves along the earth.

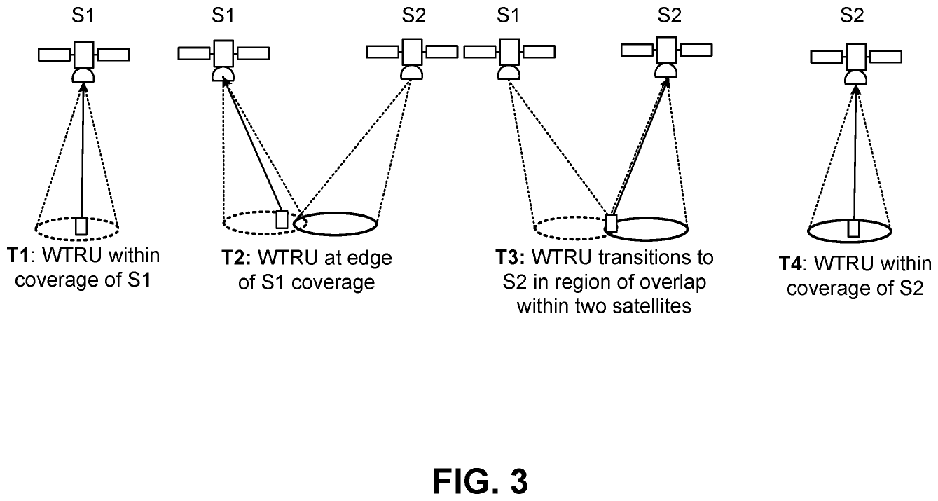

FIG. 3 illustrates an example of a WTRU within an NTN network with continuous coverage. A LEO satellite may complete a full orbit of the earth in approximately 22 minutes (depending on characteristics such as orbit, altitude, speed etc.) and may begin to serve the same geographic area again. In an NTN, there may be enough satellites within a given orbit to provide continuous coverage. Continuous coverage is defined in an NTN as once the footprint of a satellite can no longer serve a given geographic location, an incoming secondary satellite along the same orbital path may provide service to the geographic location.

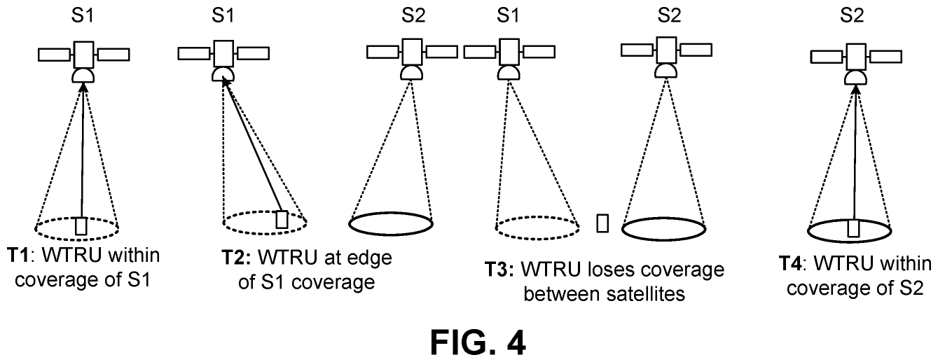

FIG. 4 illustrates another example of a WTRU within an NTN network with continuous coverage. Considering satellites move with very high velocity, a satellite footprint may (e.g., may only) provide coverage to an area for a short time. To provide continuous coverage, many satellites may follow the same orbit to ensure continuous coverage. Considering many orbits may provide global coverage, a typical LEO satellite constellation may include several thousand satellites to provide continuous global coverage. In early NTN deployments, especially in deeply rural locations (e.g., high arctic or ocean), there may be coverage gaps due to the lack of satellites within an orbit.

There may be at least of the following downsides to legacy systems for a WTRU within a discontinuous coverage gap: the WTRU may not be reachable; there may be power saving impacts; there may be unnecessary declaration of link issues; or there may be alack of network synchronization.

For the WTRU not being reachable, if a WTRU is within a coverage gap, there may be no way for the WTRU to receive network signals (e.g., paging). IoT devices may be expected to be configured with long discontinuous reception (DRX) cycles in the order of several minutes. If the paging time window (PTW) happens to fall within a coverage gap, then the WTRU may be unreachable for an extended period of time, or in some cases, unreachable indefinitely.

For the power saving impacts, if a WTRU is within a coverage gap, there may be no way for the WTRU to receive network signals. Procedures such as monitoring for paging (e.g., in this case), RLM, or cell (re)selection may cause needless WTRU power consumption, which may be an issue especially in the IoT-NTN case.

For the unnecessary declaration of link issues, a WTRU within a coverage gap may assume radio link issues even though coverage loss may be temporary. A WTRU (e.g., in this case) may unnecessarily declare bidirectional forwarding detection (BFD) or RLF, which may lead to lengthy reestablishment procedures and which may take much longer than a coverage gap duration.

For alack of network synchronization, if both the network and WTRU are not aware of both the start and duration of coverage gap, there may be miss-synchronization between the WTRU and the network. In examples, the network may assume that the WTRU may detect it is back within coverage and attempt to page the WTRU on the new cell, but the WTRU may (e.g., may still) assume it is within the coverage gap and is not monitoring paging.

The time in which these coverage gaps appear may be determined deterministically based on the satellite orbital characteristics. Such information may be leveraged to modify/adapt legacy procedures to accommodate for periodic coverage gaps in an NTN (e.g., as described herein).

Reference to NTNs has been described herein, however the examples described herein may be applicable to any scenario with discontinuous or non-contiguous coverage. The terms “discontinuous coverage,” “non-contiguous coverage,” and “coverage gap” may be used interchangeably to indicate a temporary lack of coverage as experienced by the WTRU. The terms “serving satellite/cell/beam” or “current serving satellite/cell/beam” may refer to the satellite/cell/beam which provides coverage to a WTRU prior to the beginning of a coverage gap. The terms “incoming satellite/cell/beam” or “upcoming satellite/cell/beam” may refer to the satellite/cell/beam which provides coverage to a WTRU after a coverage gap.

Examples of non-contiguous coverage gap reporting and WTRU coverage gap reporting are provided herein. Examples of information within WTRU coverage gap reporting are provided herein. The WTRU may transit a report that it has detected (e.g., determined) an upcoming coverage gap (e.g., based on received satellite assistance information). The report may include one or more of the following: a WTRU ID or information used to identify the WTRU (e.g., an RNTI, C-RNTI, TC-RNTI, 5G-S-TMSI); the incoming satellite ID, incoming target ID, or cell ID; measurements (e.g., RSRP, RSRQ) associated with the current serving satellite/cell/beam or incoming satellite/cell/beam; a flag bit which indicates the WTRU has detected a coverage gap; the time in which the WTRU estimates it will enter a coverage gap (e.g., the start of the coverage gap); the duration (e.g., estimated duration) of the coverage gap; the procedure for which the WTRU has calculated the coverage gap start time/duration; assistance information (e.g., satellite assistance information) regarding the WTRU calculation of coverage gap characteristics; the time in which the WTRU may resume normal operation; distances used in the calculation of a coverage gap determination; a flag to indicate whether an information field is the same or similar (e.g., within a threshold of difference) from previously reported or broadcasted information; a flag to indicate that an information field is different from previously broadcasted information; or a flag to indicate that a field includes delta signaling (e.g., the field value represents the difference between a previously reported or baseline value and the WTRU-estimated value).

For the flag that indicates the WTRU has detected a coverage gap, if the flag bit is set to “1”, then the WTRU has detected a coverage gap, and “0” if no coverage gap is detected.

For the time in which the WTRU estimates it will enter a coverage gap, the WTRU may include a UTC time estimate in coverage gap report (e.g., 10:00:34 UTC). In examples, the WTRU may provide a time duration (e.g., 1 s) for the remaining time before it encounters a coverage gap.

For the estimated duration of the coverage gap, the WTRU may indicate a second UTC time estimate (e.g., 10:00:35 UTC), which may represent when the WTRU expects to be out of the coverage gap. In examples, the WTRU may provide a time duration (e.g., is) for the expected duration of the coverage gap.

For the procedure for which the WTRU has calculated the coverage gap start time/duration, the WTRU may calculate the coverage gap start time/duration in a quasi-earth fixed scenario if the WTRU has calculated the coverage gap based on assistance information (e.g., satellite assistance information) or when the current serving cell may stop serving the area and neighboring cell may start serving the area. In examples (e.g., possible for the earth moving scenario), the WTRU may detect a coverage gap based on a distance calculation between itself and some reference point (e.g., cell/beam center or a serving/neighboring satellite).

For assistance information (e.g., satellite assistance information) regarding the WTRU calculation of coverage gap characteristics, the WTRU may include at least one or more of: its location information (e.g., GNSS measurements) used at the time of calculation; a time-stamp associated with when the WTRU performed the coverage gap detection/calculation; coverage footprint characteristics of the current or upcoming satellite/cell/beam; the location (e.g., GNSS coordinates) of the reference point of the incoming or current serving satellite/cell/beam; a timestamp and/or epoch time associated with when the WTRU received assistance information (e.g., satellite assistance information (e.g., SIB 31/32)) of the current serving satellite and/or an incoming satellite used in the calculation of the coverage gap; the ephemeris characteristics of the current serving satellite (e.g., satellite location, velocity, etc.); the ephemeris characteristics of the incoming satellite; the remaining time to serve of the current serving cell (e.g., t-service); or the time and duration of the incoming satellite coverage (e.g., t-service of incoming satellite).

For the time in which WTRU will resume normal operation, while in a coverage gap, the WTRU may suspend various WTRU actions and procedures while in a discontinuous coverage gap (e.g., as described herein). To synchronize the WTRU reachability with the network, the WTRU may indicate a time in which it intends to resume in-coverage operation (e.g., normal procedures (e.g., RLM, apply a target cell configuration, monitor PDCCH)). The time in which the WTRU resumes normal operation may not necessarily be the same as when the coverage gap terminates.

For the distances used in calculating a coverage gap determination, the WTRU may report one or more of the following: the distance from the WTRU to a serving satellite; the distance from the WTRU to an incoming satellite; the distance from the WTRU to a serving satellite cell/beam reference point; the distance from the WTRU to the coverage footprint edge of the serving satellite/cell/beam; the distance from the WTRU to an incoming satellite/cell/beam reference point; or the distance from the WTRU to the coverage footprint edge of the incoming satellite/cell/beam.

The information included within the WTRU coverage gap report may be dependent on the NTN deployment scenario. In examples, a WTRU may (e.g., may only) include distance information/calculations in coverage gap reporting in a LEO with earth-moving beams deployment scenario, and remaining service time (e.g., t-service) in a LEO with quasi-earth fixed beams scenario.

One or more information fields within a coverage gap report may include delta signaling from a previous coverage gap report or a baseline set of coverage gap statistics (e.g., a start time and duration). In examples, the WTRU may report the change (e.g., delta) of information from a previous transmission or coverage gap report. In examples, the WTRU may receive a baseline estimation of coverage gap statistics, for example via system information (e.g., SIB 31/32 for LTE, SIB19 for NR, or a new system information block), dedicated signaling, or another WTRU. This estimated coverage gap may include the estimated or mean start time and duration of the coverage gap. If the WTRU coverage gap estimation deviates from the baseline coverage gap estimation, the WTRU may transmit a coverage gap report that indicates the difference.

If an information field is the same as a previous coverage gap report (or a provided baseline coverage gap estimate), the WTRU may not include that piece of information or may indicate (e.g., via a flag) that this information is the same. The WTRU may not include a piece of information or indicate (e.g., via a flag) that this information field is the same if the coverage gap is within a configurable threshold from a previous coverage gap report (or the provided baseline coverage gap estimate).

Examples of coverage gap reporting configurations are provided herein. A network may enable or disable coverage gap reporting or limit coverage gap reporting to a subset of WTRUs (e.g., depending on NTN deployment characteristics or to balance signaling overhead and power consumption).

Coverage gap detection or coverage gap reporting may be configurable. In examples, the WTRU may receive a RRC configuration (e.g., coverageGap-Report), which may enable or disable coverage gap reporting for a WTRU. In examples, an information element (IE) (e.g., a new IE (e.g., coverage gap report)) may be defined to provide configuration information for WTRU coverage gap reporting. This IE may include parameters to control one or more of the following: an enable or disable indication; the signaling procedure to report the coverage gap report (e.g., via MAC CE or RRC signaling); the type of MAC CE to use (e.g., a coverage gap report MAC CE, an extended coverage gap report MAC CE, a multiple entry coverage gap report MAC CE); information to include in the coverage gap report (e.g., such as those information fields defined within this document); to send full information or delta signaling; or thresholds associated with coverage gap reporting. In examples, a threshold associated with coverage gap reporting may indicate that if a calculated coverage gap statistic differs from a baseline or previously reported value, then the WTRU should include this information field. In examples, a threshold associated with coverage gap reporting may be a distance and/or time threshold (e.g., as described herein).

Coverage gap reporting may be enabled or disabled via broadcast signaling. The WTRU may receive an indication in system information (e.g., SIB 31/32 in LTE, SIB19 in NR, or SIB1) which may enable or disable WTRU coverage gap reporting. The broadcast indication may apply as a baseline configuration until it is overridden by a dedicated configuration (e.g., via RRC configuration).

The WTRU may enable or disable cover-gap reporting implicitly based on the satellite deployment scenario. In examples, WTRU may disable coverage gap reporting if the WTRU detects that it is connected to a geo-stationary (GEO) satellite. In examples, the WTRU may enable or disable coverage gap reporting based on whether the LEO deployment scenario has earth moving beams or quasi-earth fixed beams.

Coverage gap reporting may be based on a WTRU capability. If the WTRU indicates that it is not capable of transmitting a coverage gap report (e.g., during capability reporting), then coverage gap reporting and/or detection may be disabled.

Coverage gap reporting may be temporarily disabled via an explicit indication from the network. In examples, a WTRU may receive a “skip indication” (e.g., via a data center interconnect (DCI)) to cancel a coverage gap report for an upcoming coverage gap. A skip indication may apply to the (e.g., immediately or next) upcoming coverage gap or a (e.g., future) coverage gap. The skip indication may apply to more than one coverage gap. The network may indicate that the WTRU is to skip at least one or more of the following: skip reporting for the next ‘X’ coverage gaps; skip reporting for the next ‘Y’ time units (e.g., seconds); skip reporting coverage gaps (e.g., all coverage gaps) which occur between a time window (e.g., between UTC 10:00:35 and UTC 10:10:35) (e.g., the indication may provide (e.g., additionally provide) an offset to provide periodic disabling of coverage gap reporting); skip reporting coverage gaps (e.g., all coverage gaps) which occur after being served by a specific satellite or cell (e.g., after a specific satellite or cell ID); or skip reporting coverage gaps (e.g., all coverage gaps) which are terminated by a specific satellite or cell.

Examples of conditional coverage gap reporting are provided herein. Coverage gap reporting may be enabled based on satisfaction of one or more conditions (e.g., pre-configured conditions). In examples, if the cell is located on the footprint of satellite coverage, coverage gap reporting may be enabled. A WTRU may determine that a cell is at the edge of satellite coverage via the distance between the WTRU location and satellite assistance information provided in system information. The coverage gap reporting condition may be based on characteristic(s) of the coverage gap itself.

A coverage gap report may be triggered based on at least one or more of the following conditions (e.g., possibly subject to configuration): the duration of a coverage gap being longer than a time threshold; the coverage footprint of the incoming satellite being larger than a distance threshold; the WTRU-reference point distance of the incoming serving satellite or cell being less than a distance threshold; the difference between an upcoming coverage gap and the previous coverage gap exceeding a threshold; or the difference between an upcoming coverage gap and a received estimate (e.g., via system information) of the coverage gap exceeding a threshold.

A coverage gap report may be suspended, disabled, or canceled based on at least one or more of the following conditions: the remaining time before a coverage gap occurs being less than a time threshold; the coverage footprint of the current serving satellite being less than a distance threshold; the WTRU reference point distance of the current serving satellite or cell being larger than a distance threshold; the difference between an upcoming coverage gap and the previous coverage gap being below a threshold; or the difference between an upcoming coverage gap and a received estimate (e.g., via system information) of the coverage gap being below a threshold.

Different trigger condition(s) may result in different information being transmitted. If the coverage gap is sufficiently long, the WTRU may transmit information (e.g., additional information) such as the information it used to calculate the coverage gap or the calculated distances. Different trigger condition(s) may (e.g., may also) change the type of signaling and/or message format used to transmit the coverage gap report. In examples, if the duration of the coverage gap duration is above a specific threshold, then the WTRU may transmit an extended coverage gap report (e.g., as defined herein).

Examples of signaling of a coverage gap report are provided herein. The WTRU may transmit a coverage gap report via RRC signaling and/or a MAC CE via at least one of: repurposing bits of an existing RRC message or a MAC CE; extending an existing RRC message or a MAC CE; or a (e.g., new) coverage gap report MAC CE. The coverage gap report MAC CE may be used in NTNs to provide the gNB with an estimate of a discontinuous coverage gap or to transmit information regarding one or more upcoming coverage gaps.

Examples of coverage gap report MAC CEs are provided herein. The coverage gap report MAC CE may be of fixed or variable size. The coverage gap report MAC CE may be identified by a MAC subheader with either LCID or eLCID. The coverage gap report MAC CE may include one or more fields (e.g., including information previously defined herein (e.g., a start time and duration of coverage gap, WTRU ID, upcoming cell ID, information related to serving and incoming satellite, etc.)) and possibly one or more reserve bits. The contents of the coverage gap report MAC CE may vary depending on the deployment scenario (e.g., a LEO with quasi-earth fixed beams vs a LEO with earth moving beams). Multiple coverage gap report MAC CE formats may be defined. In examples, a “short coverage gap report” may (e.g., may only) include a subset of potential information (e.g., the coverage gap start time and duration). In examples, an “extended coverage gap report” may include information (e.g., additional information) such as the ephemeris information used in at least one of: the coverage gap calculation; calculated distances; or other assistance information (e.g., satellite assistance information) requested by the network. The coverage gap report MAC CE may (e.g., may also) be single entry, in which information regarding a (e.g., only one) upcoming coverage gap may be provided. The coverage gap report MAC CE may (e.g., may also) be multiple entry, in which information for multiple upcoming coverage gaps may be provided. The coverage gap report may include delta signaling from a previous coverage gap report or baseline coverage gap provided. A field may be distinguished as a delta of a previously reported value via a flag. A field may be included within a (e.g., new) delta coverage gap report MAC CE.

RRC may control reporting of the coverage gap report MAC CE by a configuration (e.g., as defined herein). A coverage gap report may be triggered if one or more of the defined triggering conditions are satisfied and/or if requested from the gNB.

If a coverage gap report has been triggered, not canceled, and uplink shared channel (UL-SCH) resources are available for a (e.g., new) transmission and can accommodate a coverage gap report MAC CE (or extended or multiple entry coverage gap report MAC CE) plus the MAC subheader as a result of logical channel prioritization, then the MAC entity may generate a coverage gap report MAC CE. If the UL-SCH resources are insufficient for inclusion of a coverage gap report, the WTRU may trigger a scheduling request (e.g., possibly based on a configuration).

Examples of transmissions of coverage gap reports during RACH are provided herein. The WTRU may transmit a coverage gap report during the random access procedure. The WTRU may include the coverage gap report (e.g., a coverage gap report MAC CE) within Msg3, Msg5, or MsgA. Which message the coverage gap report is included within may be based on an explicit indication, for example, an indication via RRC configuration, an indication in system information, an indication within the RAR, an indication within the Msg4, or an indication within the MsgB.

Examples of suspension indications for WTRU actions/procedures are provided. If a coverage gap is detected or indicated, the gNB may configure or indicate (e.g., in a first message) to the WTRU to perform a number of action(s) associated with the coverage gap (e.g., actions to perform prior to, during, or after a coverage gap). In examples, the first message (e.g., which may be received from a NTN) may be a RRC reconfiguration message. The first message may be or include a suspend indication. The first message (e.g., the suspend indication) may indicate a first action for the WTRU to perform in relation to the coverage gap (e.g., while in the coverage gap). In examples, the first action may be a suspend action. The WTRU may receive a first message (e.g., suspend indication) that indicates a suspend action. The suspend action may suspend a radio resource control action, UL transmission, and/or DL reception. The first message (e.g., suspend indication) may refer to a WTRU action and/or control procedure (e.g., performing a UL transmission, maintenance of a timer and/or counter, application of a configuration). In examples, the first action may be an action to configure the WTRU for a power saving operation. The first message (e.g., suspend indication) may include multiple WTRU actions. If multiple WTRU actions are included in the first message (e.g., suspend indication), the actions (e.g., each action) may be provided with an associated condition for resuming the WTRU action and/or procedure (e.g., a condition to resume in-coverage operation). In examples, one condition may be provided to resume WTRU (e.g., all WTRU) actions/procedures (e.g., a condition to resume in-coverage operation), which may be indicated within the first message (e.g., suspend indication). The first message may indicate a target cell configuration.

The WTRU may receive the first message (e.g., suspend indication), for example, via an additional bit and/or bits within an existing message (e.g., by re-purposing one or more spare bits, a value range extension, or via an extension IE).

The WTRU may be provided with a table including a list of WTRU actions and/or procedures. The first message (e.g., suspend indication) may include a pointer to one or more indexes to indicate which WTRU action/procedures are to be suspended. In examples, the first message (e.g., suspend indication) may separately include information regarding the action to perform to the WTRU (e.g., all WTRU) actions/procedures pointed to. The table may have a set of actions corresponding to a WTRU action and/or procedure. A table (e.g., a separate table) may be provided with a list of suspension actions and a second pointer may be provided to link the WTRU action/procedure with an associated action. A time to execute action and/or resume normal procedures (e.g., resume in-coverage operation) may be included in the first message (e.g., suspend indication). The following example is provided below where one or more of the described features may be performed.

At 0, WTRU may be provided with Table(s), e.g., T1 and T2 (e.g., if establishing connection or if performing RRC Release/RRC Release with suspend configuration):

TABLE 1
(X)
WTRU action/procedure

1. UL transmission
2. Application of target cell configuration
3. . . .
4. N310

TABLE 2
(Y)
Suspension action

1. Stop Timer and/or counter
2. Delay by 1 s
3. . . .
4. Delay by 5 s

At 1, WTRU may receive a first message (e.g., suspend indication) with the following indication: {2,2},{1,2},{4,1}T1=10:00:34 UTC, where the set {X,Y} refers to {pointer to table T1 entry, pointer to table T2 entry} (in this example, the pointer refers to the row in the table).

At 2, at time 10:00:34 UTC, the WTRU may perform the following actions: delay pending (e.g., all pending) UL transmissions and target cell configurations by 1 s and stop the N310 timer.

In examples, the WTRU may be provided with a periodicity to apply the suspend action received in the first message (e.g., suspend indication). This periodicity may correspond to when subsequent coverage gaps are anticipated to arrive. In examples, the first message (e.g., suspend indication) may include a table and/or set of times indicating expected coverage gaps.

In examples, the suspend action received in the first message (e.g., suspend indication) may be associated with a set of validity conditions. The conditions provided within the first message (e.g., suspend indication) may be subject to the WTRU remaining stationary, or within a certain distance of the location recorded at reception of the first message (e.g., suspend indication). A validity timer may be associated with the suspend action received in the first message (e.g., suspend indication), where if the timer expires, the WTRU may discard any stored suspend action(s) received in the first message (e.g., suspend indication).

Examples of signaling for suspension indications for WTRU actions/procedures may be provided. The first message (e.g., suspend indication) may be received via one or more of the following examples: in system information, a MAC CE, a DCI, or a RACH message.

The first message (e.g., suspend indication) may be provided via an RRC message, for example, via a RRCreconfiguration, RRCResume, RRCSetup, or a new RRC message.

The first message (e.g., suspend indication) may be received in system information. If triggering an action (e.g., mobility, state transition, measurement reporting, cell (re)selection), the WTRU may re-acquire system information or perform a SI update procedure.

A MAC CE (e.g., a new MAC CE) may be defined (e.g., the control suspend MAC CE). The MAC CE may include one or more WTRU actions or procedures and an associated resume condition.

Examples of RACH messages may be Msg2, Msg4, or MsgB. The first message (e.g., suspend indication) may notify the WTRU to suspend the action indefinitely. In examples, this may be indicated via a flag bit. If indefinite suspension occurs, the WTRU may periodically monitor for an indication that it may proceed with the action, for example, via an alternative indication or toggling of the flag bit. If detecting the first message (e.g., suspend indication), the WTRU may execute one or more of the suspended actions. In examples, if a first message (e.g., suspend indication) has been provided and no condition for resuming the action has been indicated, the WTRU may assume that the action(s) have been suspended indefinitely.

The first message (e.g., suspend indication) may indicate that the WTRU performs the suspension at a given absolute time, for example, 10:00:34 UTC time. If the WTRU has not completed any ongoing procedures by the indicated time, the WTRU may halt performing the concerned procedure and continue with the suspension.

The first message (e.g., suspend indication) may indicate that the WTRU suspend the action until an absolute time, for example, 10:00:35 UTC time. If receiving/processing of the first message (e.g., suspend indication), the WTRU may suspend WTRU actions (e.g., all WTRU actions) associated to the suspend action included in first message (e.g., suspend indication). The WTRU may resume WTRU action/procedures (e.g., resume in-coverage operation) once absolute time has been reached.

The first message (e.g., suspension indication) may be based on a time duration, where the WTRU may suspend the corresponding WTRU action and/or procedure throughout this time duration. In examples, the first message (e.g., suspend indication) may provide two times (e.g., T1=10:00:34 UTC and T2=10:00:35 UTC). If reaching T1, the WTRU may suspend corresponding WTRU actions and/or procedures (e.g., all corresponding WTRU actions and/or procedures). If reaching T2, the WTRU may resume the corresponding WTRU actions and/or procedures. In examples, the WTRU may be provided with a time T1 and timer duration (e.g., T1=10:00:34 and 1 second). If reaching time T1, the WTRU may start the timer with a timer duration set to the duration provided in the first message (e.g., suspend indication). If the timer expires, the WTRU may perform the associated WTRU action and/or procedure for suspension. In examples, the WTRU may be provided with a time T1 and timer duration (e.g., T1=10:00:34 and 1 second). If reaching time T1, the WTRU may suspend the corresponding WTRU actions and/or procedures (e.g., all the corresponding WTRU actions and/or procedures and start the timer) with the timer duration set to the duration provided in the first message (e.g., suspend indication). If the timer expires, the WTRU may resume the associated WTRU action and/or procedure.

The first message (e.g., suspend indication) may be based on a WTRU location, where the WTRU may suspend the corresponding WTRU action and/or procedure while at that specified location. In examples, the first message (e.g., suspend indication) may provide two locations (e.g., location coordinates #1 and location coordinates #2). If arriving at location #1, the WTRU may suspend corresponding (e.g., all corresponding) WTRU actions and/or procedures. If reaching location #2, the WTRU may resume the corresponding WTRU actions and/or procedures. In examples, the WTRU may be provided with a location coordinate and timer duration (e.g., 1 second). If arriving at location #1, the WTRU may start the timer, with the timer duration set to the duration provided in the first message (e.g., suspend indication). If the timer expires, the WTRU may perform the associated WTRU action and/or procedure for the suspension. In examples, the WTRU may be provided with a location #1 and the timer duration (e.g., 1 second). If arriving at location #1, the WTRU may suspend the corresponding (e.g., all the corresponding) WTRU actions and/or procedures and start the timer, with the timer duration set to the duration provided in the first message (e.g., suspend indication). If the timer expires, the WTRU may resume the associated WTRU action and/or procedure. In examples, instead of a timer duration waiting before applying the suspension actions or a timer duration waiting for how long before the WTRU resumes the WTRU actions, a distance duration may be provided (e.g., 100 m south bound) that may be applied in the same way as the timer duration (e.g., apply the suspension after moving 100 m south of the location #1 or apply the suspension on reaching location #1, but resume WTRU actions after moving 100 m south of that location).

The first message (e.g., suspend indication) may be based on the distance between at least one or more of the following: the WTRU, the serving satellite, the neighboring satellite, a serving cell/beam reference point, or a neighboring cell/beam reference point. If one or more of the above distances falls below (or exceeds) a pre-configured threshold, the WTRU may suspend the corresponding WTRU actions/procedures within the first message (e.g., suspend indication). The WTRU may be provided with multiple thresholds, where one (or a set of) thresholds may indicate a condition to suspend the WTRU actions/procedures, and another (or set of) thresholds may indicate a condition to resume WTRU actions/procedures (e.g., resume in-coverage operation).

The first message (e.g., suspend indication) may be based on measurements. In examples, the WTRU may suspend one or more WTRU actions and procedures if the RSRP/RSRQ/RSNI of the serving cell falls below a configurable threshold. In examples, the suspension may apply if the RSRP of the serving cell has been below a threshold for X measurements, or within some time duration Y. The WTRU may resume normal operation once a target cell and/or neighboring cell measurements exceed a configured threshold.

The first message (e.g., suspend indication) may be based on a combination of at least one or more conditions (e.g., conditions described herein). In examples, the WTRU may be provided with a time and/or distance-based condition and combination with a RSRP-based condition to suspend and/or resume WTRU actions/procedures.

Examples of WTRU actions/procedures provided within a first message (e.g., suspend indication) for the WTRU to perform while in a coverage gap are provided. The WTRU may be configured to perform at least one or more of the described actions below if a coverage gap is detected. If a first message (e.g., suspend indication) or detection of coverage gap is received, the WTRU may perform one or more of the following actions (e.g., suspend actions): the WTRU may not perform a UL transmission (e.g., a RRC message, a physical uplink control channel (PUSCH) transmission, a MAC CE, a scheduling request (SR), or a RA message); the WTRU may suspend a RRC state transition (e.g., a state transition from RRC CONNECTED to RRC IDLEmode (e.g., to suspend an RRC state transition, the WTRU may not perform actions and/or configurations indicated in messages (e.g. the RRCResume, RRCSetup, RRCRelease, or RRCReleaseswithsuspend configuration message) until the WTRU has detected that it is no longer in a coverage gap or until a certain configured time has elapsed from the reception of the configuration message))); the WTRU may delay execution of a mobility procedure (e.g., handover from a source cell to target cell); the WTRU may suspend measurement reporting (e.g., neighbor cell measurement reporting); the WTRU may stop one or more timers (e.g., T300, T301, T302, T304, T310, T311, T312, T316, T319, T320); the WTRU may suspend one or more counters (e.g., N310, N311); the WTRU may delay application of a configuration (e.g., an RRC reconfiguration for a target cell); the WTRU may suspend actions related to RLM (e.g., monitoring one or a subset of reference signals or frequencies); the WTRU may suspend actions related to RLF; the WTRU may suspend actions related to RRC re-establishment (e.g., the WTRU may maintain MAC and RBs, the WTRU may not release any configurations, PDCP entities, or discard security keys); or the WTRU may trigger/transmit a coverage gap report (e.g., via RRC signaling or via indication to lower layers to transmit a coverage gap report MAC CE).

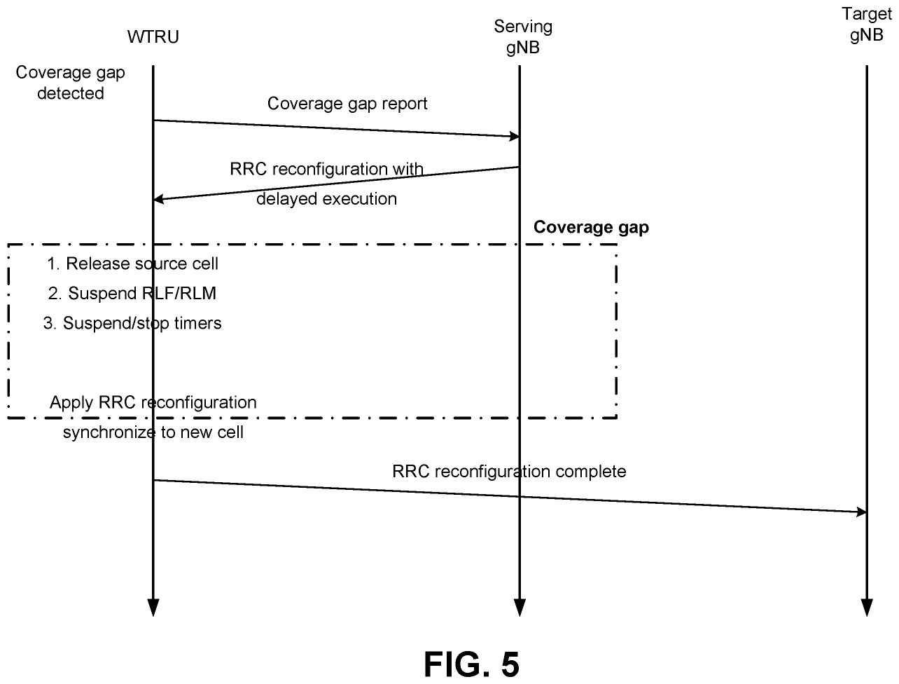

FIG. 5 illustrates an example for suspended mobility during a coverage gap. One or more of the following may be performed (e.g., as shown in FIG. 5):

At 1, the WTRU may detect (e.g., determine) an upcoming coverage gap (e.g., based on received assistance information), and may transmit a coverage gap report to the gNB (e.g., based on the determination of the coverage gap). The WTRU or another WTRU may have indicated the existence of a coverage gap within this cell.

At 2, the network may provide a first message, which may be a RRC reconfiguration message. The first message may be or include a suspend indication. The first message may indicate WTRU actions/procedures for the WTRU to perform/suspend (e.g., suspend action(s)), condition(s) to resume in-coverage operation, and/or a target cell configuration while in discontinuous coverage (e.g., on a condition of detecting a coverage gap).

At 3, if entering the coverage gap, WTRU may release a source cell (e.g., which may belong to an NTN) and suspend procedures (e.g., perform the suspend action(s)) as indicated.

At 4, towards completion of traversing (or alternatively at reaching an end of) a coverage gap or based on conditions outlined in the first message (e.g., the suspend indication), the WTRU may perform a second action, apply a target cell configuration, and synchronize to a target cell (e.g., which may belong to an NTN). The second action may resume the suspend action(s)/resume normal procedures (e.g., resume in-coverage operation).

At 5, if there is a successful completion of handover to a target cell (e.g., the cell after coverage gap), the WTRU may transmit a second message, which may be a RRC reconfiguration complete message.

In examples, if the coverage gap is indicated by the network (and not detected by the WTRU), the WTRU may skip (e.g., not perform) its own determination of the coverage gap at 1.

In examples, the target cell after leaving the coverage gap may be the same cell that the WTRU was connected to before encountering the coverage gap. The WTRU (e.g., in this case) may keep using the RRC configuration that it was using before the coverage gap detection and resume the UL/DL operation.

Based on previous indications from the concerned WTRU (or another WTRU), the network may be aware of gaps within a coverage area of a cell of a gNB and may configure (e.g., pre-emptively configure) the WTRU (e.g., if the WTRU is handed over to the concerned gNB, if the concerned cell is added as a PSCell in DC, etc.) to suspend the UL/DL operation if the coverage gap is detected.

Examples of enhanced CHO are provided. The WTRU may be provided with conditions for when to apply/evaluate the CHO configuration. In examples, the WTRU may (e.g., may only) evaluate the CHO configuration after a certain time. In examples, the WTRU may (e.g., may only) evaluate the CHO configuration based on a distance exceeding (or falling below) a pre-configured threshold.

The WTRU may maintain a CHO configuration after release of the source cell (e.g., PCell, sPCell). In examples, the CHO configuration may include a flag which indicates that the WTRU should maintain the configuration if the source cell is released.

Examples of enhanced RRC connection reestablishment may be provided. The WTRU may be provided with the conditions for if to apply a modified RRC connection reestablishment procedure. The conditions may be detected at of the start of the coverage gap. The conditions may (e.g., may additionally) include starting all or part of the RLF and RRC connection reestablishment procedure shortly before or during a coverage gap. These conditions may include detection of N310 out-of-sync indications from the physical layer, the start of the timer T310, the expiration of T310, the start of T311, the expiration of T311, or expiration of a new timer which starts if any of the preceding conditions occur.

If certain conditions are detected, the WTRU may suspend any of the timers currently running (e.g., T310, T311) and may pause a re-attempting sync to the PCell/serving cell until the time when the coverage gap ends. The WTRU may (e.g., may additionally) delay RLF detection, cell selection, and/or re-establishment until the time at which the coverage gap ends. The WTRU may cancel timer T310 if detecting the conditions and start (e.g., immediately start) timer T311 when the coverage gap ends. The WTRU may attempt to directly camp and re-establish on a neighbor cell which was indicated by the network before the start of the coverage gap. This may void performing a scan of supported RATs/frequencies.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-15. (canceled)

16. A wireless transmit/receive unit (WTRU), comprising:
a processor configured to:
determine a coverage gap based on an event trigger;
transmit a coverage gap report based on the determination of the coverage gap, wherein the coverage gap report includes at least an indication that the WTRU has detected the coverage gap, when the WTRU will enter the coverage gap, and a duration of the coverage gap; and
based on the WTRU entering the coverage gap, not send an uplink (UL) transmission.

17. The WTRU of claim 16, wherein the processor is further configured to:
based on the WTRU entering the coverage gap: suspend one or more radio resource control (RRC) timers and corresponding actions; or suspend radio link monitoring.

18. The WTRU of claim 16, wherein the processor is further configured to:
receive a first message, wherein the first message indicates at least a condition to resume in-coverage operation.

19. The WTRU of claim 18, wherein the processor is further configured to:
based on the condition to resume in-coverage operation being satisfied, send an UL transmission.

20. The WTRU of claim 19, wherein the processor is further configured to:
based on the condition to resume in-coverage operation being satisfied: resume one or more RRC timers and corresponding actions; or resume radio link monitoring.

21. The WTRU of claim 18, wherein the condition to resume in-coverage operation includes an absolute universal time coordinated (UTC) being reached or a target measurement being above a threshold.

22. The WTRU of claim 18, wherein:
the first message further indicates a target cell configuration, and
based on the condition to resume in-coverage operation being satisfied, the processor is further configured to apply the target cell configuration and synchronize to a target cell.

23. The WTRU of claim 22, wherein the processor is further configured to:
transmit a second message, wherein the second message is transmitted to the target cell.

24. The WTRU of claim 16, wherein the coverage gap report further includes an incoming target ID or a cell ID.

25. The WTRU of claim 16, wherein the event trigger is a start or an expiration of a timer.

26. A method associated with a wireless transmit/receive unit (WTRU), comprising:
determining a coverage gap based on an event trigger;
transmitting a coverage gap report based on the determination of the coverage gap, wherein the coverage gap report includes at least an indication that the WTRU has detected the coverage gap, when the WTRU will enter the coverage gap, and a duration of the coverage gap; and
based on the WTRU entering the coverage gap, not sending an uplink (UL) transmission.

27. The method of claim 26, further comprising:
based on the WTRU entering the coverage gap: suspending one or more radio resource control (RRC) timers and corresponding actions; or suspending radio link monitoring.

28. The method of claim 26, further comprising:
receiving a first message, wherein the first message indicates at least a condition to resume in-coverage operation.

29. The method of claim 28, further comprising:
based on the condition to resume in-coverage operation being satisfied, sending an UL transmission.

30. The method of claim 29, further comprising:
based on the condition to resume in-coverage operation being satisfied: resuming one or more RRC timers and corresponding actions; or resuming radio link monitoring.

31. The method of claim 28, wherein the condition to resume in-coverage operation includes an absolute universal time coordinated (UTC) being reached or a target measurement being above a threshold.

32. The method of claim 28, wherein the first message further indicates a target cell configuration, further comprising:
based on the condition to resume in-coverage operation being satisfied, applying the target cell configuration and synchronizing to a target cell.

33. The method of claim 32, further comprising:
transmitting a second message, wherein the second message is transmitted to the target cell.

34. The method of claim 26, wherein the coverage gap report further includes an incoming target ID or a cell ID.

35. The method of claim 26, wherein the event trigger is a start or an expiration of a timer.
